(19) United States
(12) Patent Application Publication
(10) Pub. No.: US 2003/0231086 A1
(43) Pub. Date: Dec. 18, 2003

(54) Dielectric resonator and high frequency circuit element using the same

(75) Inventors: Mariko Ishikawa, Osaka (JP); Kojiro Okuyama, Nara (JP); Akira Enokihara, Nara (JP)

Correspondence Address: McDERMOTT, WILL & EMER, 600 13th Street, N.W., Washington, DC, 20005-3096, US

(73) Assignee: Matsushita Electric Industrial Co., Ltd.

(21) Appl. No.: 10/459,618

(22) Filed: Jun. 12, 2003

(30) Foreign Application Priority Data
Jun. 12, 2002 (JP) P2002-171194
Jul. 17, 2002 (JP) P2002-208129

(51) Int. Cl. H01P 7/10

(52) U.S. Cl. 333/219.1

(57) ABSTRACT

A dielectric resonator of the present invention becomes excited in the TM mode and is provided with a dielectric material, a shielding cavity surrounding the above-described dielectric material and coupling antennas attached to the above-described shielding cavity so as to penetrate from the outside to the inside of the above-described shielding cavity, wherein it is preferable for the above-described dielectric material to be formed in a pillar form extending in the longitudinal direction, wherein it is preferable for the above-described shielding cavity to be formed so as to be hollow and so as to extend in the longitudinal direction and wherein it is preferable for the above-described dielectric material to be secured to the inside of the above-described shielding. cavity in a manner such that the longitudinal direction of the dielectric material is the same as the longitudinal direction of the above-described shielding cavity.

### FIELD OF THE INVENTION

The present invention relates to a dielectric resonator and a high frequency circuit element, such as a filter or a duplexer that uses the same.

### BACKGROUND OF THE INVENTION

A dielectric resonator is one of the basic components of a high frequency circuit element, such as a filter or a duplexer. In the case wherein a dielectric material for microwaves is provided in a hollow resonator formed of a shielding cavity, the wavelength of an electromagnetic wave that propagates through the dielectric material is reduced to 1/√εr (εr is the relative dielectric constant of the dielectric material) so that miniaturization of the resonator can be achieved and, therefore, this is indispensable for the miniaturization of a high frequency circuit.

In general, a dielectric resonator using the TE_{01δ} mode is used as a low-loss (high Q) dielectric resonator. This is formed by fixing a resonating part made of dielectric ceramic to a support member made of a low-loss material having a low dielectric constant, using adhesive, or the like, so that the resonating part is located in the center of a metal housing in a columnar form or in a prism form provided with an input/output part by means of coupling loops or antennas.

The above-described dielectric resonator is provided within a high frequency circuit for the purpose of allowing the passage of, or removal of, a specific frequency component.

FIGS. 28A and 28B show the configuration of a representative dielectric resonator that resonates according to the TE_{01δ} mode. FIG. 28A is a horizontal cross sectional view and FIG. 28B is a longitudinal cross sectional side view.

In these figures, a dielectric ceramic in a columnar form is denoted as 11, a hollow metal housing in a columnar form is denoted as 12, a support member is denoted as 13, coupling antennas are denoted as 14 and a frequency adjustment plate is denoted as 15. In such a dielectric resonator the filter and the oscillation function of the resonator may sometimes malfunction when the amount of frequency adjustment is large wherein the frequency of unnecessary resonant modes greatly shift and approach the desired resonant mode even in the case wherein an unnecessary adjacent mode is at a certain distance away from a desired resonant mode at the time of design because frequency adjustment of the resonator is carried out by sliding a frequency adjustment plate 15 made of metal upward and downward relative to a metal housing 12 at the time of adjustment of the frequency of the resonator.

In addition, the resonant electrical field rotates in a concentric form within the dielectric material in a columnar form in the TE_{01δ} mode and, therefore, adjustment and coupling are difficult to achieve and coupling antennas 14, which are inserted for input/output, is of a form along the electrical field that is distributed in a concentric form wherein, in some cases, unnecessary resonance occurs with the metal housing 12, which is a shielding cavity. Furthermore, strong input/output coupling is necessary in order to manufacture a broad-band filter.

### SUMMARY OF THE INVENTION

Accordingly, a main object of the present invention is to provide a low-loss dielectric resonator and a high frequency circuit element that uses the same wherein a desired resonant mode is at a sufficient distance away from an unnecessary adjacent mode and wherein adjustment can be easily carried out.

Another object of the present invention is to provide a low-loss dielectric resonator and a high frequency circuit element that uses the same wherein a strong input/output coupling can be gained.

Still another object, characteristics and benefits of the present invention are made clear in the description below.

The dielectric resonator of the present invention is provided with a dielectric material, a shielding cavity surrounding the above-described dielectric material and coupling antennas attached by allowing the above-described shielding cavity to penetrate from the inside to the outside of the antennas, and is excited according to the TM mode.

The above-described dielectric material is formed in a pillar form extending in the longitudinal direction, the above-described shielding cavity is formed in a hollow form extending in the longitudinal direction and the above-described dielectric material is fixed within the above-described shielding cavity so that the longitudinal direction thereof is along the longitudinal direction of the above-described shielding cavity in the dielectric resonator of the present invention.

The above-described coupling antennas are, preferably, in linear form and the portion of the above-described coupling antennas that are inserted into the above-described shielding cavity is provided with a conductive coupling body extending to the outside of the above-described coupling antennas in a line form and having a diameter that is greater than the diameter of the above-described coupling antennas in a line form, wherein the above-described coupling body has, at least a portion in which the thickness is no greater than the above-described diameter in the dielectric resonator of the present invention.

A high frequency circuit element of the present invention is provided with a dielectric resonator of the present invention.

### BRIEF DESCRIPTION OF THE DRAWINGS

These and other objects as well as advantages of the invention will become clear through the following description of the preferred embodiments of the invention with reference to the accompanying drawings, wherein:

FIG. 1 is a longitudinal cross sectional side view of a dielectric resonator, according to the preferred embodiments of the present invention;

FIG. 2 is a horizontal cross sectional view of the dielectric resonator of FIG. 1;

FIG. 3 is a graph showing the frequency characteristics of the dielectric resonator of FIG. 1;

FIG. 4 is a graph showing the result of an electromagnetic field analysis of the frequency characteristics of the dielectric resonator of FIG. 1;

FIG. 5 is a graph showing the relationships between the ratio of the length in the longitudinal direction of the shielding cavity to that of the dielectric material and the Q value in the dielectric resonator of FIG. 1;

FIG. 6 is a graph showing the relationship between the ratio of the length in the width direction of the dielectric material to that of the shielding cavity of the dielectric resonator of FIG. 1 and the frequency intervals of the desired mode and of the closest mode;

FIG. 7 is a graph showing the relationship between the ratio of the length in the width direction of the dielectric material to that of the shielding cavity of the dielectric resonator of FIG. 1 and the frequency intervals of the desired mode and of the closest mode;

FIG. 8 is a graph showing the relationship between the ratio of the length in the width direction of the dielectric material to that of the shielding cavity of the dielectric resonator of FIG. 1 and the frequency intervals of the desired mode and of the closest mode;

FIG. 9 is a graph showing the relationship between the ratio of the length in the width direction of the dielectric material to that of the shielding cavity of the dielectric resonator of FIG. 1 and the frequency intervals of the desired mode and of the closest mode;

FIG. 10 is a graph showing the relationship between the ratio of the length in the longitudinal direction to that in the width direction of the dielectric material of the dielectric resonator of FIG. 1 and the difference in the resonant frequency between the desired mode and the closest mode;

FIG. 11 is a graph showing the result of electromagnetic field analysis of the dielectric resonator of FIG. 1;

FIG. 12 is a graph showing the relationship between the ratio of the length in the width direction of the dielectric material to that of the shielding cavity of the dielectric resonator of FIG. 1 and the Q value;

FIG. 13 is a horizontal cross-sectional view of a dielectric resonator, according to another preferred embodiment of the present invention;

FIG. 14 is a horizontal cross-sectional view of the dielectric resonator of FIG. 13;

FIG. 15 is a penetrative perspective view showing the inside of the shielding cavity of a dielectric resonator, according to still another preferred embodiment of the present invention;

FIG. 16 is a penetrative perspective view showing the inside of the shielding cavity of a dielectric resonator, according to still another preferred embodiment of the present invention;

FIG. 17 is a penetrative perspective view showing the inside of the shielding cavity of a dielectric resonator, according to still another preferred embodiment of the present invention;

FIG. 18 is a penetrative perspective view showing the inside of the shielding cavity of a dielectric resonator, according to still another preferred embodiment of the present invention;

FIG. 19A is a frequency characteristics graph of the insertion loss of the dielectric resonator of FIG. 15;

FIG. 19B is a frequency characteristics graph of the insertion loss of the dielectric resonator of FIG. 17;

FIG. 19C is a frequency characteristics graph of the insertion loss of the dielectric resonator of FIG. 18;

FIG. 20A is a penetrative perspective view showing the inside of the shielding cavity of a dielectric resonator, according to still another preferred embodiment of the present invention;

FIG. 20B is a penetrative perspective view showing the inside of the shielding cavity of a dielectric resonator, according to still another preferred embodiment of the present invention;

FIG. 21 is a horizontal cross-sectional view showing one example of a high-frequency filter that includes a dielectric resonator of the present invention;

FIG. 22 is a frequency characteristics graph of the high frequency filter of FIG. 21;

FIG. 23 is a horizontal cross-sectional view showing another example of a high-frequency filter that includes a dielectric resonator of the present invention;

FIG. 24 is a horizontal cross-sectional view showing one example of a high-frequency filter that includes a dielectric resonator of the present invention;

FIG. 25 is a horizontal cross-sectional view showing another example of a high-frequency filter that includes a dielectric resonator of the present invention;

FIG. 26 is a horizontal cross-sectional view showing one example of a high-frequency filter that includes a dielectric resonator of the present invention;

FIG. 27 is a horizontal cross-sectional view showing another example of a high-frequency filter that includes a dielectric resonator of the present invention;

FIG. 28A is a horizontal cross-sectional view of a TE_{01δ}mode resonator according to a prior art; and

FIG. 28B is a longitudinal cross-sectional side view of the TE_{01δ} mode resonator according to the prior art.

In all these figures, like components are indicated by the same numerals.

### DETAILED DESCRIPTION OF THE PREFERRED EMBODIMENTS

The present invention is described in detail below based on the embodiments shown in the drawings.

(Embodiment 1)

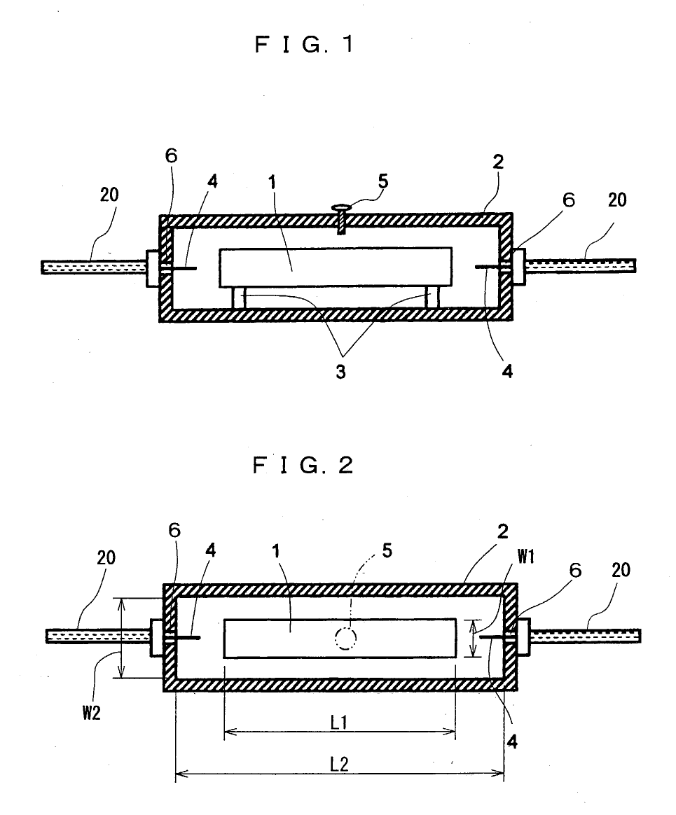

FIG. 1 is a longitudinal cross sectional side view of a dielectric resonator, according to a preferred embodiment of the present invention, and FIG. 2 is a horizontal cross sectional view thereof.

The dielectric resonator of this embodiment is provided with a dielectric material 1 in rectangular parallelepiped form made of a ceramic material, or the like. The dielectric material 1 is placed in, and secured to, a hollow shielding cavity 2 in a rectangular parallelepiped form via support members 3 so that the longitudinal direction thereof (the direction from left to right in the drawings) is along the longitudinal direction of the shielding cavity 2. The support members 3 are made of alumina, polytetrafluoro-ethylene, or the like.

The dielectric material 1 is placed in the center position within the shielding cavity 2 in both the longitudinal and in the width directions perpendicular to this longitudinal direction. The shielding cavity 2 is made of metal and is formed of a main body case part in a box form open on the top, as well as of a case cover part that covers the opening in this main body case part.

The dielectric material 1 and the support members 3, as well as support members 3 and the shielding cavity 2, respectively, are adhered to each other by means of adhesive. The support members 3 are made of a material having a dielectric constant that is equal to, or lower than, the dielectric constant of the dielectric material 1 and having a small loss and, for example, forsterite is selected for this. In the case wherein the support members 3 can easily be processed, they may be formed of a dielectric ceramic so as to be integrated in the dielectric material 1.

Through holes 6, respectively, are created on both ends of the shielding cavity 2 in the longitudinal direction so that coupling antennas 4, forming input/output paths, respectively, are inserted from the respective through holes 6 into the shielding cavity 2 toward the dielectric material 1. The coupling antennas 4 are made of, for example, metal wires and are connected to central conductors of coaxial cables 20.

A frequency adjustment screw 5 is provided in the upper wall of the shielding cavity 2 at a position opposite to the dielectric material 1 for adjustment of the resonant frequency by varying the amount of insertion. The frequency adjustment screw 5 may be provided on a side wall.

The forms and characteristics of the dielectric material 1, the shielding cavity 2 and the support members 3, which become a resonant portion, are appropriately set in the above-described configuration and, thereby, it becomes possible for the dielectric resonator to resonate according to a resonating mode, which is referred to as the TM_{11δ} mode in a resonator having a rectangular cross section so that a TM_{11δ} mode resonator can be implemented in the configuration shown in FIGS. 1 and 2. The configuration shown in FIGS. 1 and 2 functions as a resonator and it is possible to use it as a single stage band filter.

### EXAMPLE 1

The dimensions of the resonating part of a dielectric material 1 are 5.0 mm×5.0 mm×33.0 mm in the dielectric resonator shown in FIGS. 1 and 2. Zr—Ti—Mg—Nb—O-based dielectric ceramic having dielectric characteristics wherein relative dielectric constant ε=40 to 45 and fQ product=42000 to 53000, more concretely, Zr—Ti—Mg—Nb—O-based dielectric ceramic having relative dielectric constant ε=42 and fQ product=42000, for example, is used for the material of the dielectric material 1.

Oxygen-free copper is used for a shielding cavity 2. The inner dimensions of the shielding cavity 2 are 10.0 mm×10.0 mm×51 mm.

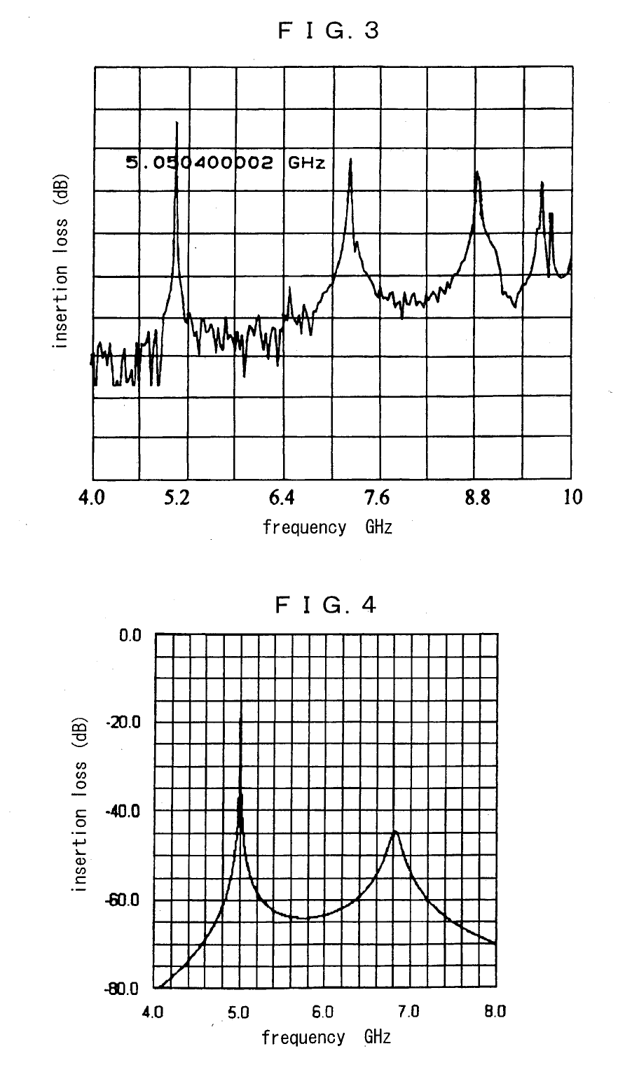

FIG. 3 shows the measurement result of the frequency characteristics of the insertion loss of this dielectric resonator. The resonance peak appears at approximately 5 GHz (5.050400002 GHz) as shown in FIG. 3. This resonance peak has been confirmed as being resonant in the TM_{11δ} mode as a result of the analysis of the electrical field distribution. No resonance peaks have been confirmed at a frequency lower than 5 GHz. The distance between the peak in TM_{11δ} mode, which is a desired resonant mode, and the peak of an unnecessary resonant mode is not less than 2 GHz and, therefore, the desired resonant mode and the unnecessary resonant mode are sufficiently separated from each other.

Coupling antennas 4 are placed along the electrical field that spreads in the longitudinal direction of the shielding cavity 2. Accordingly, unnecessary resonance hardly occurs in this dielectric resonator. Adjustment of the resonant frequency in the dielectric resonator is carried out by varying the amount of insertion of a frequency adjustment screw 5 into the shielding cavity 2. Accordingly, only a slight amount of shift in the unnecessary resonant mode is necessary even in the case that the unnecessary resonant mode shifts. Accordingly, a dielectric resonator can be gained wherein the peak of the desired resonant mode and the peak of the unnecessary resonant mode can be sufficiently separated from each other.

FIG. 4 shows the frequency characteristics of the insertion loss, according to the result of electromagnetic field analysis at that time. The result of electromagnetic field analysis, shown in FIG. 4, and the result of the actual measurement of FIG. 3 appear to agree with each other.

### EXAMPLE 2

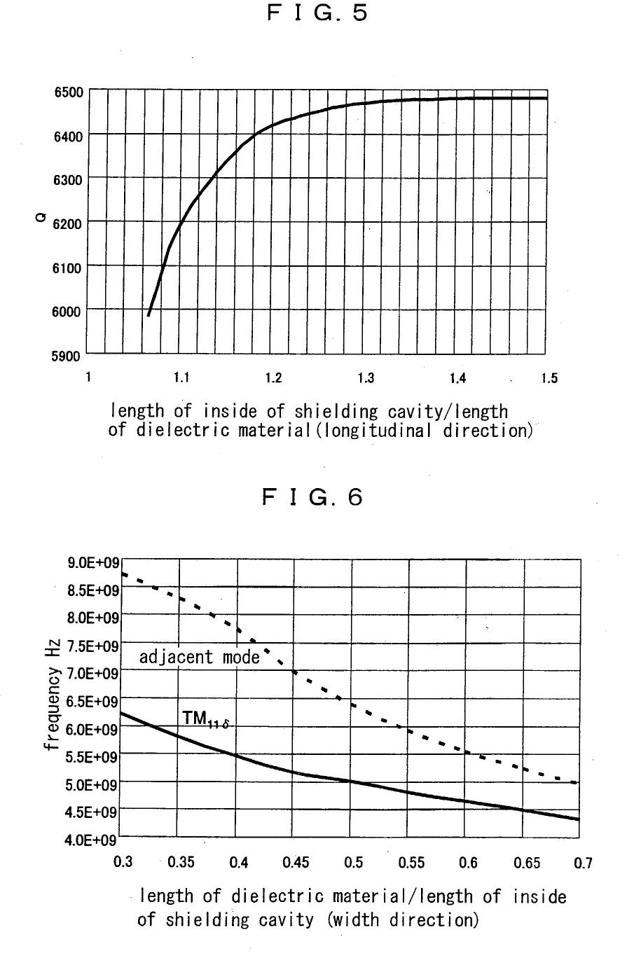

The same Zr—Ti—Mg—Nb—O-based dielectric ceramic as in the above-described Example 1 was used, and the dimensions of a dielectric material 1 and the length of the respective sides of a shielding cavity 2 in the width direction, which is perpendicular to the longitudinal direction thereof, were set at the same values as in Example 1 while the length of the longitudinal direction of the shielding cavity 2 was varied so that the electromagnetic field analysis gained thereby concerning the Q value of the dielectric resonator was carried out. The result of this is shown in FIG. 5.

FIG. 5 confirms that a dielectric resonator having a high Q value was gained in the case wherein the ratio (L2/L1) of length L2 in the longitudinal direction of the inside of the shielding cavity 2 to length L1 in the longitudinal direction of the dielectric material 1, which is the resonator part shown in FIG. 2, was no less than 1.10. Here, the above-described ratio may be set at, for example, 1.2 or 1.3, or greater, in the case that a high Q value is desired even if the size of the dielectric resonator becomes relatively great.

It is preferable for the upper limit of this ratio to be from approximately 1.1 to 3.5, for example, taking into consideration the sizes of the resonator and of the filter formed of the resonator as well as ease of coupling, and it is more preferable for this ratio to be from approximately 1.2 to 2.5, for example.

### EXAMPLE 3

The same Zr—Ti—Mg—Nb—O-based dielectric ceramic as in the above-described Example 1 was used in the configuration shown in FIGS. 1 and 2 and the dimensions of a dielectric material 1, which is the resonating part, were set at 5.0 mm×5.0 mm×33.0 mm and oxygen-free copper was used for a shielding cavity 2 so as to form a dielectric resonator. The inner dimensions of the shielding cavity 2 were set at 10.0 mm×10.0 mm×51 mm. The frequency characteristics of the insertion loss of this dielectric resonator were measured in order to confirm that this dielectric resonator has a resonant peak in the TM_{11δ} mode at 5.0 GHz.

Dielectric materials are prepared wherein the lengths of the respective sides of the dielectric material 1, which is a resonating part, in the width direction perpendicular to the longitudinal direction are fixed at 5.0 mm while the lengths in the longitudinal direction are varied from 25 mm to 40 mm at increments of 5 mm and wherein the ratio of length L2 in the longitudinal direction of the inside of the shielding cavity 2 to length L1 in the longitudinal direction of the dielectric material 1 is used in the same manner as in the above-described Example 2 so that this ratio (L2/L1) is in the range of from 1.27 to 2.04. These dielectric materials were placed within, in the center, the above-described shielding cavity 2 using support members 3 made of polytetrafluoro-ethylene and the resonant frequency in the mode adjacent to the TM_{11δ} mode was measured and then it was confirmed that these modes were separated from each other by 900 MHz, or greater, throughout the entire region.

Next, dielectric materials were prepared wherein the length in the longitudinal direction of the dielectric material 1, which is a resonating part, was fixed at 33.0 mm and length W1 of one side in the width direction (upward and downward directions in FIG. 2) perpendicular to the longitudinal direction was adjusted from 3 mm to 7 mm in increments of 0.5 mm. These dielectric materials were placed within the above-described shielding cavity 2 using the support members 3 made of polytetrafluoro-ethylene and the result of the measurement of the resonant frequency of the resonant peak in the TM_{11δ} mode as well as of the adjacent peak is shown in FIG. 6.

It can be understood from FIG. 6 that a dielectric resonator can be gained wherein the adjacent peak is separated from resonant frequency 5.0 GHz in the TM_{11δ} mode by no less than 750 MHz in the case wherein ratio (W1/W2) of length W1 of one side in the width direction perpendicular to the longitudinal direction of dielectric material 1 to length W2 of one side in the width direction perpendicular to the longitudinal direction of the inside of the shielding cavity 2 is set at 0.60, or lower. That is to say, it is preferable for the ratio to be set at 0.60, or lower, as described above in order to secure a distance of 750 MHz, which is 15% of 5.0 GHz, or more, vis-à-vis the adjacent peak and the ratio may be set at 0.70, or less, for example, in the case wherein a distance of 500 MHz, which is 10% of 5.0 GHz, or more, is desired to be secured vis-à-vis the adjacent peak. Here, though there is no specific lower limit, approximately 0.2, for example, is preferable, taking the sides of the gained resonator into consideration.

In addition, the Q value of a dielectric resonator wherein ratio (W1/W2) of length W1 of one side in the width direction of the dielectric material 1 to length W2 of one side in the width direction of the inside of the shielding cavity 2 is 0.60, or lower, showed a high value from 7300 to 5500.

### EXAMPLE 4

The same Zr—Ti—Mg—Nb—O-based dielectric ceramic as in the above-described Example 1 was used in the configuration shown in FIGS. 1 and 2 and the dimensions of a dielectric material 1, which is the resonating part, were set at 12.5 mm×12.5 mm×82 mm and oxygen-free copper was used for a shielding cavity 2 so as to form a dielectric resonator. The inner dimensions of the shielding cavity 2 were set at 25.0 mm×25.0 mm×140.0 mm. The frequency characteristics of the insertion loss of this dielectric resonator were measured in order to confirm that this dielectric resonator has a resonant peak in the TM_{11δ} mode at 2.0 GHz.

Dielectric materials are prepared wherein lengths W1 of the respective sides of the dielectric material 1, which is a resonating part, in the width direction perpendicular to the longitudinal direction are fixed at 12.5 mm while lengths L1 in the longitudinal direction are varied from 70 mm to 90 mm at increments of 5 mm and wherein ratio (L2/L1) of length L2 in the longitudinal direction of the inside of the shielding cavity 2 to length L1 in the longitudinal direction of the dielectric material 1 is used in the same manner as in the above-described Example 2 so that this ratio is in the range of 1.56 to 2.0. These dielectric materials were placed in the above-described shielding cavity 2 using support members 3 made of polytetrafluoro-ethylene and the resonant frequency in the mode adjacent to the TM_{11δ} mode was measured and then it was confirmed that these modes were separated from each other by 550 MHz, or greater, throughout the. entire region.

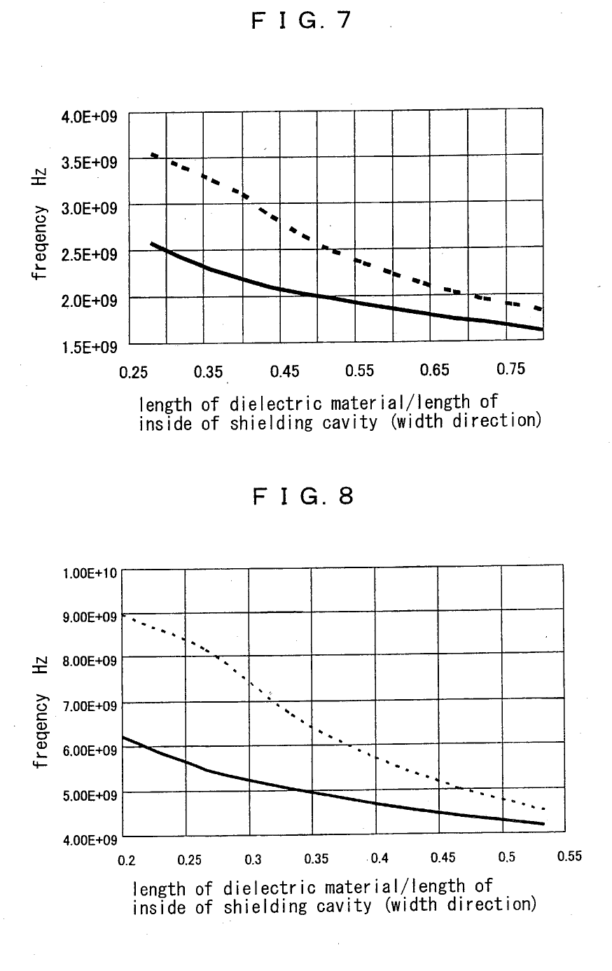

Next, dielectric materials were prepared wherein the length in the longitudinal direction of the dielectric material 1, which is a resonating part, was fixed at 82 mm and length W1 of one side in the width direction perpendicular to the longitudinal direction was adjusted from 7 mm to 20 mm in increments of 1 mm. These dielectric materials were placed within the above-described shielding cavity 2 using the support members 3 made of polytetrafluoro-ethylene and the result of the measurement of the resonant frequency of the resonant peak in the TM_{11δ} mode, as well as of the adjacent peak, is shown in FIG. 7.

It is confirmed, in accordance with FIG. 7, that a dielectric resonator can be gained wherein the adjacent peak is separated from resonant frequency 2.0 GHz in the TM_{11δ} mode by no less than 300 MHz in the case wherein ratio (W1/W2) of length W1 of one side in the width direction perpendicular to the longitudinal direction of the dielectric material 1 to length W2 of one side in the width direction perpendicular to the longitudinal direction of the inside of the shielding cavity 2 is set at 0.64, or lower. That is to say, it is preferable for the ratio to be set at 0.64, or lower, as described above in order to secure a distance of 300 MHz, which is 15% of 2.0 GHz, or more, vis-à-vis the adjacent peak and the ratio may be set at 0.75, or less, for example, in the case wherein a distance of 200 MHz, which is 10% of 2.0 GHz, or more, is desired to be secured vis-à-vis the adjacent peak.

In addition, the Q value of a dielectric resonator wherein ratio (W1/W2) of length W1 of one side in the width direction of the dielectric material 1 to length W2 of one side in the width direction of the inside of the shielding cavity 2 is 0.64, or lower, showed a high value from 14800 to 9730.

Though in each of the above-described embodiments the Zr—Ti—Mg—Nb—O-based dielectric ceramic (relative dielectric constant εr=42, fQ product=42000) is used as the dielectric ceramic that becomes the resonating part, the same effects can, of course, be gained even when a material made from other components having a different εr and fQ is utilized.

### EXAMPLE 5

In the configuration shown in FIGS. 1 and 2, a dielectric material 1, which is the resonating part, made of Ba—Ti—O-based dielectric ceramic having dielectric characteristics wherein the relative dielectric constant ε=32 to 37 and wherein fQ product=17000 to 23000, more concretely, made of Ba—Ti—O-based dielectric ceramic having dielectric characteristics wherein ε=35 and wherein fQ product=20000 having dimensions of 5.0 mm×5.0 mm×30.0 mm is used and oxygen-free copper is used for a shielding cavity 2 so as to form a dielectric resonator. The inner dimensions of the shielding cavity 2 are 15.0 mm×15.0 mm×60.0 mm. The frequency characteristics of insertion loss of this dielectric resonator were measured and it was confirmed that the dielectric resonator has a resonance peak in TM_{11δ} at 5.0 GHz.

Dielectric materials are prepared wherein lengths W1 of the respective sides of the dielectric material 1, which is a resonating part, in the width direction perpendicular to the longitudinal direction are fixed at 5.0 mm while lengths L1 in the longitudinal direction are varied from 20 mm to 50 mm at increments of 5 mm and wherein ratio (L2/L1) of length L2 in the longitudinal direction of the inside of the shielding cavity 2 to length L1 in the longitudinal direction of the dielectric material 1 is used in the same manner as in the above-described Example 2 so that this ratio is in the range of 1.20 to 3.0. These dielectric materials were placed in the above-described shielding cavity 2 using support members 3 made of polytetrafluoro-ethylene and the resonant frequency in the mode adjacent to the TM_{11δ} mode was measured and then it was confirmed that these modes were separated from each other by 800 MHz, or greater, throughout the entire region.

Next, dielectric materials were prepared wherein length L1 in the longitudinal direction of the dielectric material 1, which is a resonating part, was fixed at 30.0 mm and length W1 of one side in the width direction perpendicular to the longitudinal direction was adjusted from 3 mm to 8 mm in increments of 0.5 mm. These dielectric materials were placed within the above-described shielding cavity 2 using the support members 3 made of polytetrafluoro-ethylene and the result of the measurement of the resonant frequency of the resonant peak in the TM_{11δ} mode as well as of the adjacent peak is shown in FIG. 8.

It is confirmed, in accordance with FIG. 8, that a dielectric resonator can be gained wherein the adjacent peak is separated from resonant frequency 5.0 GHz in the TM_{11δ} mode by not less than 750 MHz in the case wherein ratio (W1/W2) of length W1 of one side in the width direction perpendicular to the longitudinal direction of the dielectric material 1 to length W2 of one side in the width direction perpendicular to the longitudinal direction of the inside of the shielding cavity 2 is set at 0.50, or lower. That is to say, it is preferable for the ratio to be set at 0.50, or lower, as described above, in order to secure a distance of 750 MHz, which is 15% of 5.0 GHz, or more, vis-à-vis the adjacent peak and the ratio may be set at 0.55, or less, for example, in the case wherein a distance of 500 MHz, which is 10% of 5.0 GHz, or more, is desired to be secured vis-à-vis the adjacent peak.

In addition, the Q value of a dielectric resonator wherein ratio (W1/W2) of length W1 of one side in the width direction of the dielectric material 1 to length W2 of one side in the width direction of the inside of the shielding cavity 2 is 0.50, or lower, showed a high value from 5890 to 5480.

### EXAMPLE 6

The same Ba—Ti—O-based dielectric ceramic as in the above-described Example 5 was used in the configuration shown in FIGS. 1 and 2 and the dimensions of a dielectric material 1, which is the resonating part, were set at 13.0 mm×13.0 mm×70.0 mm and oxygen-free copper was used for a shielding cavity 2 so as to form a dielectric resonator. The inner dimensions of the shielding cavity 2 were set at 38.0 mm×38.0 mm×140.0 mm. The frequency characteristics of the insertion loss of this dielectric resonator were measured in order to confirm that this dielectric resonator has a resonant peak in the TM_{11δ} mode at 2.0 GHz.

Dielectric materials are prepared wherein lengths W1 of the respective sides of the dielectric material 1, which is a resonating part, in the width direction perpendicular to the longitudinal direction are fixed at 13.0 mm while lengths L1 in the longitudinal direction are varied from 60 mm to 110 mm at increments of 10 mm and wherein ratio (L2/L1) of length L2 in the longitudinal direction of the inside of the shielding cavity 2 to length L1 in the longitudinal direction of the dielectric material 1 is used in the same manner as in the above-described Example 2 so that this ratio is in the range of 1.27 to 2.33. These dielectric materials were placed in the above-described shielding cavity 2 using support members 3 made of polytetrafluoro-ethylene and the resonant frequency in the mode adjacent to the TM_{11δ} mode was measured and then it was confirmed that these modes were separated from each other by 400 MHz, or greater, throughout the entire region.

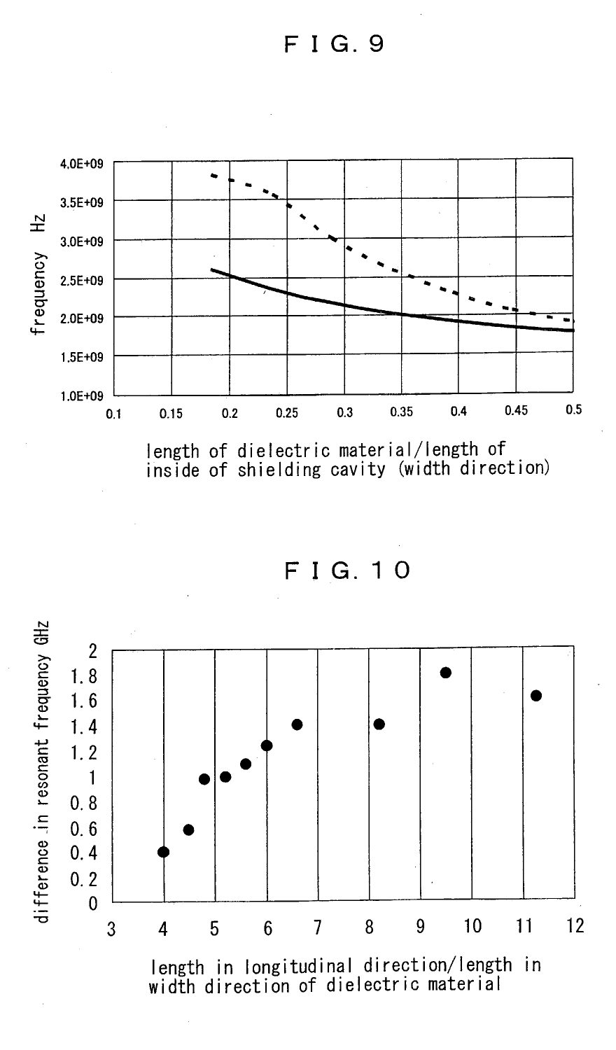

Next, dielectric materials were prepared wherein the length in the longitudinal direction of the dielectric material 1, which is a resonating part, was fixed at 70.0 mm and length W1 of one side in the width direction perpendicular to the longitudinal direction was adjusted from 7 mm to 19 mm in increments of 2 mm. These dielectric materials were placed within the above-described shielding cavity 2 using the support members 3 made of polytetrafluoro-ethylene and the result of the measurement of the resonant frequency of the resonant peak in the TM_{11δ} mode, as well as of the adjacent peak, is shown in FIG. 9.

It can be understood from FIG. 9 that a dielectric resonator can be gained wherein the adjacent peak is separated from resonant frequency 2.0 GHz in the TM_{11δ} mode by no less than 300 MHz in the case wherein ratio (W1/W2) of length W1 of one side in the width direction perpendicular to the longitudinal direction of the dielectric material 1 to length W2 of one side in the width direction perpendicular to the longitudinal direction of the inside of the shielding cavity 2 is set at 0.42, or lower. That is to say, it is preferable for the ratio to be set at 0.42, or lower, as described above, in order to secure a distance of 300 MHz, which is 15% of 2.0 GHz, or more, vis-à-vis the adjacent peak and the ratio may be set at 0.45, or less, for example, in the case wherein a distance of 200 MHz, which is 10% of 2.0 GHz, or more, is desired to be secured vis-à-vis the adjacent peak.

In addition, the Q value of a dielectric resonator wherein ratio (W1/W2) of length W1 of one side in the width direction of the dielectric material 1 to length W2 of one side in the width direction of the inside of the shielding cavity 2 is 0.42, or lower, showed a high value from 13300 to 12400.

### EXAMPLE 7

A dielectric material 1, using Zr—Ti—Mg—Nb—O-based dielectric ceramic in the same manner as in the above-described Example 1, and a shielding cavity 2, made of oxygen-free copper, were prepared so as to form the configuration shown in FIGS. 1 and 2. As for the dimensions of the shielding cavity 2, length W2 in the width direction perpendicular to the longitudinal direction is in a range of from 8 mm to 16 mm and length L2 in the longitudinal direction is set at 60 mm. The dielectric materials 1, which are resonating parts, were prepared wherein length W1 in the width direction perpendicular to the longitudinal direction is increased from 4 mm in 1 mm increments and these were installed within the above-described shielding cavity 2 using support members 3 made of polytetrafluoro-ethylene and the resonant frequency of the mode adjacent to the TM_{11δ} mode was measured. The length of the dielectric material 1 is adjusted so that the resonance peak of the TM_{11δ} mode can be gained at 5.0 GHz.

The results exhibiting the relationship between ratio (L1/W1) of length L1 in the longitudinal direction of dielectric material 1 to length W1 in the width direction perpendicular to the longitudinal direction and the difference in the resonant frequency between the TM_{11δ} mode and the adjustment mode are shown in FIG. 10.

As length W1 in the width direction increases and ratio (L1/W1) of the length in the longitudinal direction of the dielectric material 1 to the length in the width direction decreases, the unnecessary resonant mode approaches the TM_{11δ} mode and when length W1 in the width direction of dielectric material 1 is 7 mm, or greater, the unnecessary resonant mode has a resonant frequency lower than that of the TM_{11δ} mode. In the case wherein ratio (L1/W1) of length L1 in the longitudinal direction of the dielectric material 1 to length W1 in the width direction is 4.5, or greater, it was confirmed that the unnecessary resonant mode can be separated from the resonant frequency of 5 GHz in the TM_{11δ} mode by 0.5 GHz, or greater, which is 10%, or greater, than that of the resonant frequency.

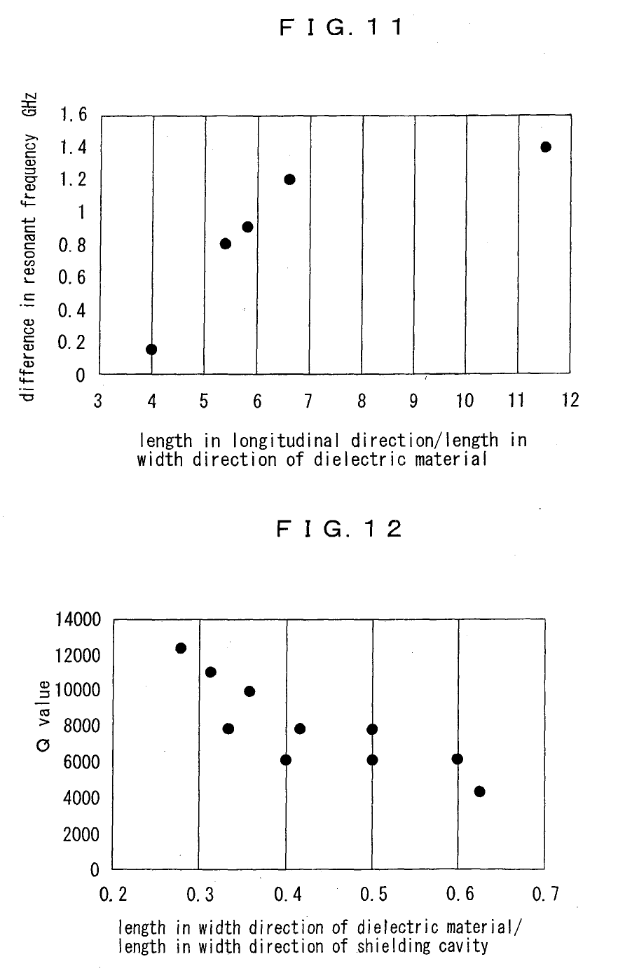

In addition, FIG. 11 shows the result wherein electromagnetic field analysis concerning several points is carried out on a dielectric resonator using a dielectric material having a dielectric constant of 50 and an fq 30000 as the dielectric material 1. The same tendency as in FIG. 10 can be confirmed in accordance with FIG. 11.

In addition, it is preferable to set the upper limit of this ratio, for example, from approximately 4.5 to 10, taking into consideration that as length L1 in the longitudinal direction of the dielectric material 1 increases, the entire volume of the shielding cavity 2, which contains the dielectric material 1, increases and the unnecessary resonant mode in the closest proximity varies.

Furthermore, FIG. 12 shows the relationship between ratio (W1/W2) of length W1 in the width direction of the dielectric material 1 to length W2 in the width direction of shielding cavity 2 and the Q value of the TM_{11δ} mode at 5 GHz concerning the above-described dielectric material 1 and shielding cavity 2.

In the case wherein ratio (W1/W2) of the length in the width direction of the dielectric material 1 to that of shielding cavity 2 exceeds 0.6, the Q value of the resonator is lowered to a value no higher than one half of the Q value of the material and, therefore, it is preferable for the ratio of the shielding cavity in the width direction to the shielding cavity 2 to be 0.6, or less.

In addition, it is preferable for the lower limit of this ratio to be, for example, from approximately 0.3 to 0.6, taking into consideration that as length W2 in the width direction of the shielding cavity 2 increases, the entire volume of the shielding cavity 2 increases.

(Embodiment 2)

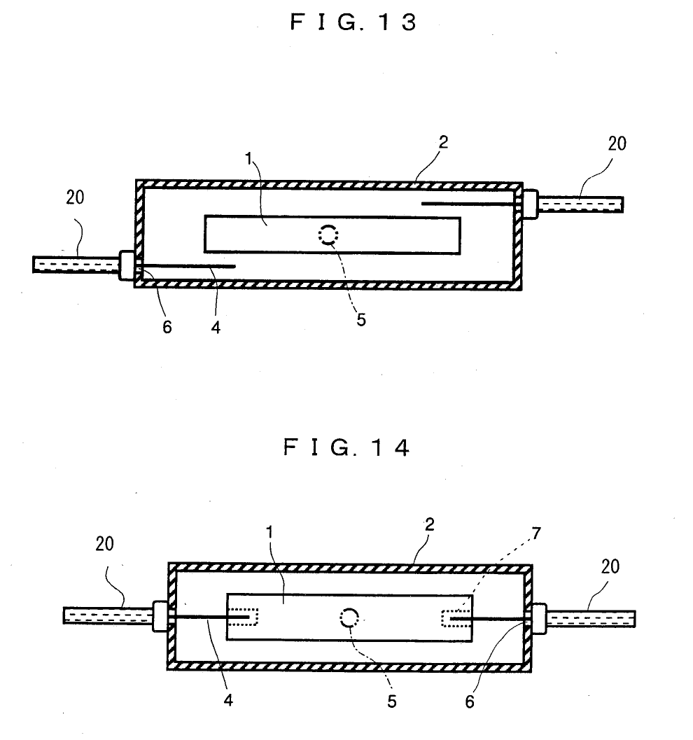

In contrast to the above-described Embodiment 1 wherein coupling antennas 4 have a length wherein the edges thereof do not reach to the ends of the dielectric material 1, the length of the coupling antennas 4 is extended in this Embodiment 2 as shown in horizontal cross sectional views of FIGS. 13 and 14.

In this embodiment the above-described Zr—TI—Mg—Nb—O-based dielectric ceramic was used for a dielectric material 1, which is the resonating part having the dimensions of 5.0 mm×5.0 mm×30.0 mm and oxygen-free copper was used for a shielding cavity 2, in order to prepare a dielectric resonator. The inner dimensions of the shielding cavity 2 are 10.0 mm×10.0 mm×50 mm.

Silver wires, having diameters of 1.0 mm and lengths of 15 mm, are placed along the side surface of dielectric material 1 as coupling antennas 4 in the dielectric resonator of FIG. 13. The coupling antennas 4 extend in the longitudinal direction of the dielectric material 1 so that the ends thereof extend between the dielectric material 1 and the inner surfaces of the shielding cavity 2 in this dielectric resonator.

Antenna insertion holes 7 having diameters of 2.0 mm and depths of 8 mm are created in the dielectric material 1 into which the end portions of the coupling antennas 4 are inserted in the dielectric resonator of FIG. 14.

In addition, for the purpose of comparison, a dielectric resonator having coupling antennas 4 with diameters of 1.0 mm and lengths of 9 mm in the configuration shown in the above-described FIG. 1 is also prepared.

Both of the above-described dielectric resonators exhibit a resonance peak in the TM_{11δ} mode at approximately 5.15 GHz. The input/output coupling (hereinafter referred to as “Qe”) was- calculated from these resonance peaks and was found to be 38 in the configuration of FIG. 13, and 35 in the configuration of FIG. 14, which were Qes lower than in the comparison example of FIG. 1 wherein the input/output coupling was calculated and found to be 85 in the comparison example, that is to say, the configurations of FIGS. 13 and 14 show strong input/output coupling.

Qes of these coupling antennas are gained having strengths that are proportional to the diameters and lengths of these coupling antennas and, therefore, the diameters and the lengths of these coupling antennas may be set in accordance with the required Qes. Here, in the case of the configuration of FIG. 13, the lengths of the coupling antennas are limited to lengths wherein the ends of the portions along the sides in the longitudinal direction of the dielectric material can only reach to the center of dielectric material 1, while in the case of the configuration of FIG. 14, the coupling antennas may penetrate through the dielectric material 1.

(Embodiment 3)

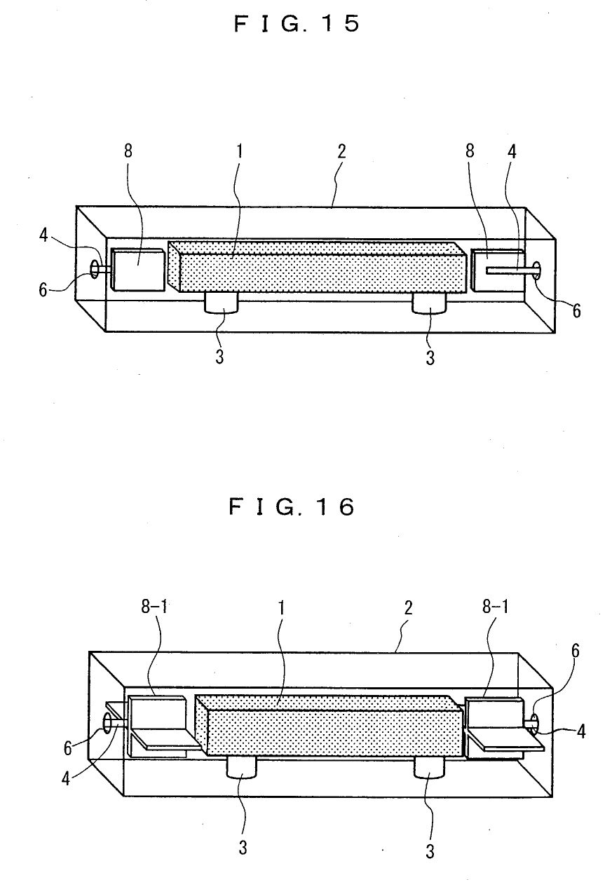

FIG. 15 is a penetrative perspective view, showing the inside of the shielding cavity of the dielectric resonator, according to Embodiment 3 of the present invention.

In the dielectric resonator of this embodiment, a dielectric material 1 in rectangular parallelepiped form made of ceramic, or the like, in the same manner as in the above-described embodiment is placed within and fixed to a shielding cavity 2 in a hollow rectangular parallelepiped form via support members 3 made of low-loss material having a low dielectric constant, such as alumina, so that the longitudinal direction (the direction from left to right in the figure) of the dielectric material 1 is along the longitudinal direction of the above-described shielding cavity 2. The shielding cavity 2 in the hollow rectangular parallelepiped form is formed of a main body case part in a box form open on one surface and of a cover part for covering the above-described opening. This shielding cavity 2 is made of metal. The dielectric material 1 and the support members 3, as well as the support members 3 and the shielding cavity 2, respectively, are adhered to each other by means of adhesive in this embodiment.

Through holes 6 are created on both ends of the shielding cavity 2 in the longitudinal direction so that coupling antennas 4, forming input/output paths, respectively, are inserted from the respective through holes 6 into the shielding cavity 2 toward the dielectric material 1. These coupling antennas 4 in line forms are connected on the outside of the shielding cavity 2 to coaxial cables via connectors, or the like, which are not shown.

This embodiment has the following configuration in order to gain strong input/output coupling and in order to easily carry out adjustment thereof.

That is to say, conductive coupling bodies 8 in rectangular plate forms are provided in the portions of the coupling antennas 4 in line forms that are inserted into the shielding cavity 2 in this embodiment. These coupling bodies 8 are made of, for example, copper and are formed in plate forms that are larger than the coupling antennas 4 so as to extend to the outside in the diameter direction of the coupling antennas 4 in line forms. Thereby, strong input/output coupling can be gained in comparison with the case wherein coupling is carried out solely by the coupling antennas 4 in line forms.

Input/output coupling of an arbitrary strength can be gained by appropriately setting the lengths and the diameters of the coupling antennas 4 in line forms as well as the areas and the thicknesses of the coupling bodies 8.

Though strong input/output coupling is gained in the above-described Embodiment 2, the ends of the coupling antennas extend through narrow spaces in the longitudinal direction of the dielectric material 1 and of shielding cavity 2 or are inserted into dielectric material 1 and, therefore, fine adjustment of the input/output coupling is difficult.

On the contrary, in this embodiment, the coupling bodies 8 have plate forms thinner than the wire diameters of the coupling antennas 4 in line forms and, thus, these thin coupling bodies 8 can be processed such as by bending and cutting so that input/output coupling can easily be adjusted.

Here, the coupling antennas in line forms are not limited to linear forms but rather may be in curved or bent line forms, while the cross-sections thereof are not limited to being circular, but rather may be in square or other forms.

In addition, the coupling bodies may be of forms having portions of which the thicknesses are equal to, or smaller than, the diameters of the wires of the coupling antennas and these coupling bodies may be formed so as to be integrated with the coupling antennas.

### (Example)

Zr—Ti—Mg—Nb—O-based dielectric ceramic (dielectric constant εr=42, fQ product=42000) was used for a dielectric material 1, which is a resonating part having dimensions of 5.0 mm×5.0 mm×30.0 mm, and oxygen-free copper was used for a shielding cavity 2 in the configuration shown in this FIG. 15 in order to prepare a dielectric resonator. The inner dimensions of the shielding cavity 2 were 10.0 mm×10.0 mm×50 mm.

Coupling bodies 8 made of copper size 5 mm square having thicknesses of 0.3 mm are fixed by means of soldering to the ends portions of coupling antennas 4 in line forms having diameters of 0.7 mm and lengths of 9 mm.

### (Comparative Examples 1 and 2)

On the other hand, the same dielectric resonator as shown in FIG. 1 is prepared as a comparison example. The configuration of this dielectric resonator is the same as that of the above-described FIG. 15, except for coupling bodies 8, and the same reference symbols are attached to corresponding parts.

Two comparison examples, 1 and 2, show the same configuration but the sizes of coupling antennas 4 in line forms differ from each other. That is to say, in Comparative Example 1 coupling antennas 4 in line forms had diameters of 0.7 mm and lengths of 9.5 mm, while in Comparative Example 2 coupling antennas 4 in line forms had diameters of 2.0 mm and lengths of 9.5 mm.

The above-described example and Comparative Examples 1 and 2 all exhibit a resonance peak in the TM_{11δ} mode at approximately 5.15 GHz. Qes were calculated from these resonance peaks and were found to be approximately 153 in Comparative Example 1 and approximately 62 in Comparative Example 2, while the Qe was approximately 42 in the Example, which is a low Qe in comparison with Comparative Examples 1 and 2, that is to say, strong input/output coupling was exhibited in the Example.

In Comparative Example 1 the diameters of the coupling antennas 4 in line forms are 0.7 mm, which is comparatively fine, and adjustment of the input/output coupling was easy, but the input/output coupling became weak, while in Comparative Example 2 the diameters of the coupling antennas 4 in line forms are 2.0 mm and, therefore, adjustment of the input/output coupling was difficult due to the mechanical strength thereof, though strong input/output coupling was gained.

In contrast to this, in this example strong input/output coupling was gained and, in addition, coupling bodies 8 in plate forms having thicknesses of 0.3 mm were provided so that processes such as bending and cutting could be carried out on these coupling bodies 8 in plate forms and, thereby, input/output coupling was easily adjustable.

(Embodiment 4)

FIG. 16 is a perspective view corresponding to FIG. 15 of Embodiment 4 of the present invention.

The dielectric resonator of this embodiment has the same configuration as the above-described FIG. 15, except for coupling bodies 8.

Each of coupling bodies 8 is formed in a plate form in the above-described Embodiment 3, while each of coupling bodies 8-1 is formed in an X-form of two plates that intersect each other through their centers.

Concretely, the coupling bodies 8-1 made of copper, in X-forms of two 5 mm square plates having a thickness of 0.3 mm that intersect each other through their centers were secured by means of soldering to portions 3 mm from the ends of coupling antennas 4 in line forms having a diameter of 0.7 mm and a length of 13 mm within a shielding cavity 2 in a configuration having the same dielectric material 1 and shielding cavity 2 as in the above-described examples.

The dielectric resonator of this embodiment has a resonance peak in the TM_{11δ} mode at approximately 5.15 GHz and the Qe calculated from this resonance peak was found to be 46.

The areas of the coupling bodies 8-1 in this embodiment are greater than those of the above-described Embodiment 3 and, therefore, further fineness of adjustment of the input/output coupling becomes possible.

(Embodiment 5)

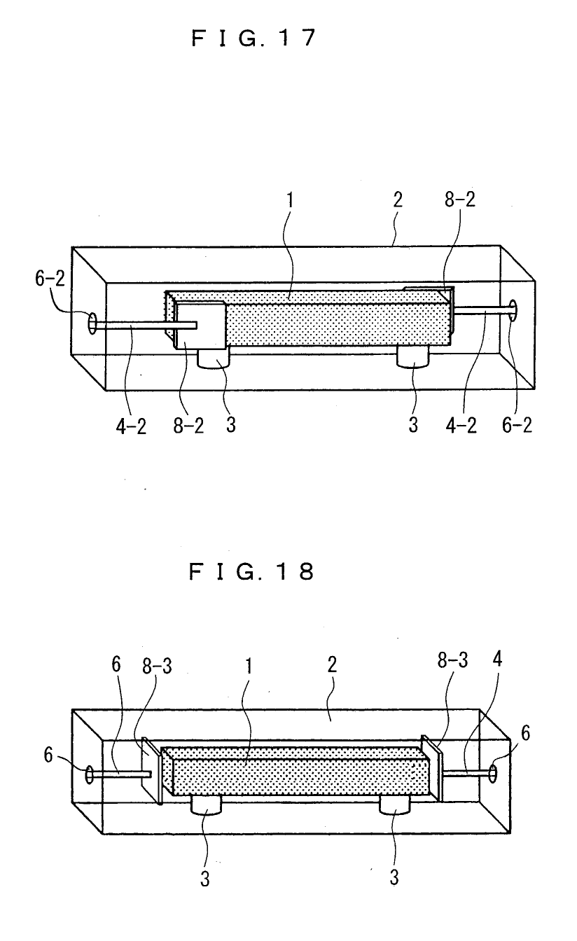

FIG. 17 is a perspective view corresponding to FIG. 15 of still another embodiment of the present invention.

The dielectric resonator of this embodiment has the same configuration as in the above-described FIG. 15 except for the arrangement of coupling bodies 8. Through holes 6 and coupling antennas 4 in line forms are placed in a concentric manner relative to the dielectric material 1 and the shielding cavity 2, that is to say, they are placed in the centers of both end surfaces perpendicular to the longitudinal direction of the shielding cavity 2 in the above-described Embodiment 3 while, concretely, through holes 6 and coupling antennas 4-2 in line forms are placed at positions 3.75 mm away from the centers in a configuration having the same dielectric material 1 and shielding cavity 2 as in the above-described examples and coupling bodies 8-2 in rectangular plate forms located at the end portions of the coupling antennas 4-2 in line forms are placed so as to face the sides along the longitudinal direction of the dielectric material 1 in this embodiment.

These coupling bodies 8-2 are formed by fixing 5 mm square copper plates having a thickness of 0.3 mm to the portions 3 mm from the ends of the coupling antennas 4-2 in line forms having diameters of 0.7 mm and lengths of 13 mm by means of soldering.

The dielectric resonator of this embodiment has a resonance peak in the TM_{11δ} mode at approximately 5.2 GHz and the Qe calculated from this resonance peak was found to be 49.

The coupling bodies 8-2 are placed parallel to the sides of the dielectric material 1 and, thereby, a design becomes possible wherein the distances between the dielectric material 1 and the shielding cavity 2 in the longitudinal direction are small so that further miniaturization of the TM_{11δ} mode resonator becomes possible.

(Embodiment 6)

FIG. 18 is a perspective view corresponding to FIG. 15 of yet another embodiment of the present invention.

The dielectric resonator of this embodiment has the same configuration as in the above-described FIG. 15, except for coupling bodies 8.

In contrast to the above-described Embodiment 3 wherein the coupling bodies 8 in plate forms are placed so that the plate surfaces thereof are along the longitudinal direction of the dielectric material 1, coupling bodies 8-3 in plate forms in this embodiment are placed so that the plate surfaces thereof face the end surfaces of a dielectric material 1, which are perpendicular to the longitudinal direction.

Concretely, the coupling bodies 8-3 are formed by fixing 5 mm square copper plates having a thickness of 0.3 mm to the ends of coupling antennas 4 in line forms having diameters of 0.7 mm and lengths of 9 mm by means of soldering in a configuration having the same dielectric material 1 and shielding cavity 2 as in the above-described examples.

This dielectric resonator has a resonance peak in the TM_{11δ} mode at approximately 5.25 GHz and the Qe calculated from this resonance peak was found to be 53.

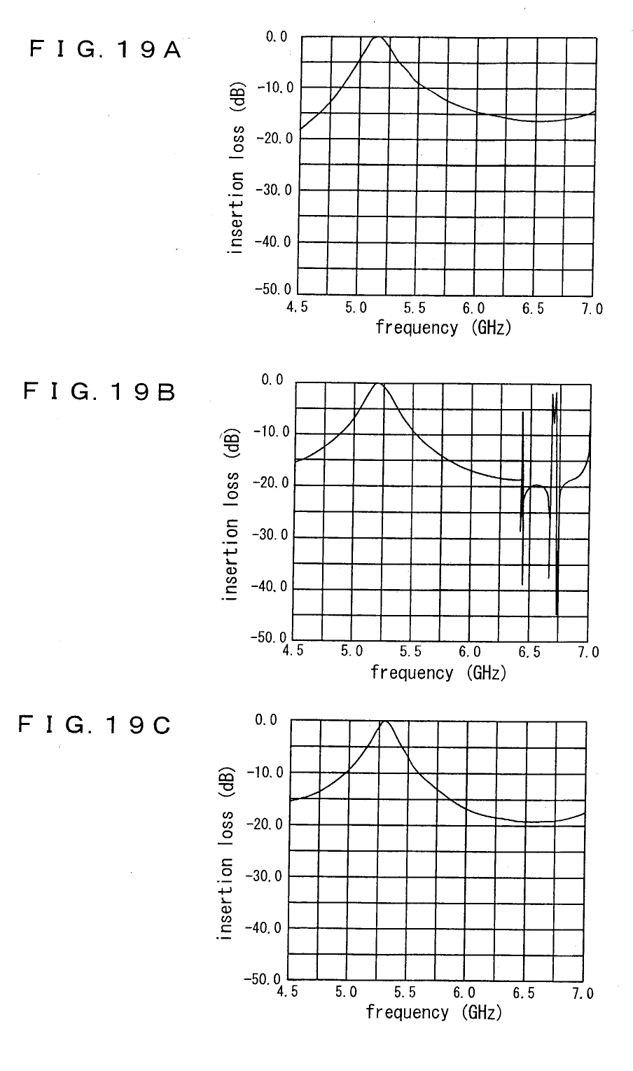

Next, frequency characteristics graphs of insertion loss of dielectric resonators of the above-described Embodiment 3, Embodiment 5 and Embodiment 6 are shown in FIGS. 19A to 19C.

It can be understood that unnecessary resonances of other modes do not occur up to 7 GHz in Embodiments 3 and 6 shown in FIGS. 19A and 19C, while unnecessary resonances occur from approximately 6.4 GHz in Embodiment 5 shown in FIG. 19B. As a result, it can be understood that a dielectric resonator wherein a desired resonant mode is sufficiently separated from an unnecessary adjacent mode in the case wherein the coupling bodies are placed between the end surfaces of the dielectric material 1 perpendicular to the longitudinal direction and the inner surfaces of the shielding cavity 2 along the longitudinal direction of the dielectric material 1.

(Embodiment 7)

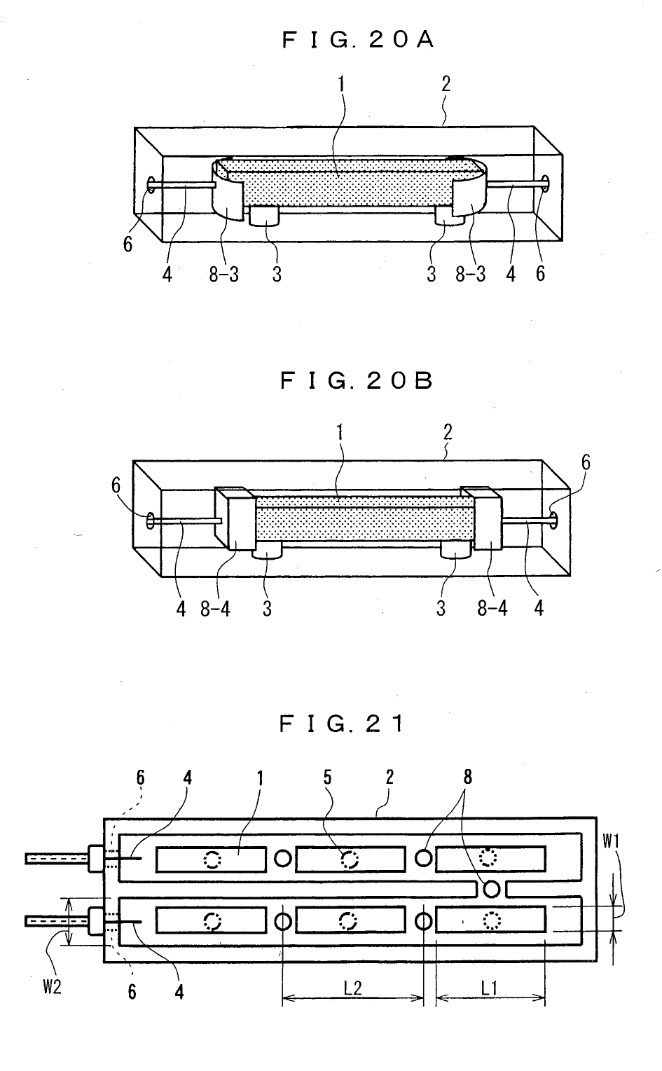

Coupling bodies 8-3 in curved plate forms may be formed so as to surround a dielectric material 1 as shown in FIG. 20A or the dielectric material 1 may be surrounded by coupling bodies 8-4 in box forms made of plates connected to each other as shown in FIG. 20B, according to another embodiment of the present invention.

Though the coupling bodies in plate forms are made of copper, according to each of the above-described Embodiments 3 to 7, they are not limited to copper and may be made of another metal, such as silver, or they may be made so that only the surfaces are conductive while gaining the same effects and, for example, coupling bodies are gained by applying a metal coating to a resin surface.

Though the shielding cavities of the above-described respective Embodiments 1 to 7 are all formed of metal, the same effects can, of course, be gained as long as the surfaces of a shielding cavity to which a metal coating is applied are conductive even in the case wherein the entirety of the shielding cavity is not formed of metal.

Though the dielectric materials of the above-described respective Embodiments 1 to 7 are secured to the shielding cavities via support members, protrusions for support may be formed at, for example, the bottom surface of a shielding cavity so that a dielectric material can be fixed to these protrusions, according to another embodiment of the present invention.

Though the dielectric materials of the above-described respective Embodiments 1 to 7 are formed in rectangular parallelepiped forms, a dielectric material may be formed in another prism form or may be formed in a columnar form and the shielding cavity is not limited to being in a hollow rectangular parallelepiped form, but rather may be of another hollow prism form or of a hollow columnar form.

Though the coupling antennas in line forms of the above-described respective Embodiments 1 to 7 are inserted into the shielding cavities in the longitudinal direction of the shielding cavities, they may be inserted in the direction perpendicular to the longitudinal direction of the shielding cavities, according to other embodiments of the present invention.

The dielectric resonators according to the embodiments of the present invention can easily be manufactured for the frequency band of 30 GHz and below and, in particular, it has been confirmed that an appropriate coupling can easily be gained in the frequency band from 1 GHz to 11 GHz and, therefore, a dielectric resonator and a filter having improved characteristics can be gained in this frequency band.

(Embodiment 8)

Though there is one dielectric material and one shielding cavity in each of the above-described Embodiments 1 to 7, a high frequency circuit component, such as a high frequency filter, can be formed by, for example, aligning a plurality of dielectric materials in the longitudinal direction of the shielding cavity or by aligning shielding cavities, in which dielectric materials are placed, in the lateral direction and by providing coupling windows between the shielding cavities.

Since such a high frequency circuit element is provided with a dielectric resonator according to the present invention, a filter, a resonator, and the like, can be formed by using a low-loss dielectric resonator wherein a desired resonant mode is sufficiently separated from an unnecessary adjacent mode.

In addition, a filter, a resonator, and the like, can be formed using a dielectric resonator having strong input/output coupling wherein this input/output coupling can easily be adjusted.

FIG. 21 is a horizontal cross sectional view showing one example of a high frequency filter wherein a plurality of dielectric materials is arranged in the longitudinal direction of the shielding cavity. In this figure dielectric materials are denoted as 1, a shielding cavity is denoted as 2, coupling antennas are denoted as 4, frequency adjustment screws are denoted as 5 and through holes are denoted as 6 in the same manner as in the above-described respective embodiments. Stage-stage coupling adjustment screws, which are an example of members for adjusting inter-section coupling between dielectric elements, are denoted as 8.

### (Example)

Three pieces of Zr—Ti—Mg—Nb—O-based dielectric ceramic having dielectric characteristics wherein the relative dielectric constant ε=40 to 45 and fQ product=42000 to 53000, concretely a Zr—Ti—Mg—Nb—O-based dielectric ceramic wherein the relative dielectric constant ε=42 and fQ product=42000, as a dielectric material 1 which is a resonating part, are aligned in the longitudinal direction of the shielding cavity within the shielding cavity 2 made of oxygen-free copper having inner dimensions of 10.0 mm×10.0 mm×122 mm and, thereby, a filter is manufactured. As for the dimensions of the dielectric material 1, the cross-sections are all 5 mm square and the lengths of the dielectric materials placed in the center are 30.5 mm while the lengths of the dielectric materials placed on both ends are 30 mm. Alumina tubes having outer diameters of 3 mm and inner diameters of 2 mm are used for support members of the dielectric materials 1, silver wires having diameters of 2 mm are used for coupling antennas 4 and frequency adjustment screws 5 as well as stage-stage coupling adjustment screws 8 are also provided.

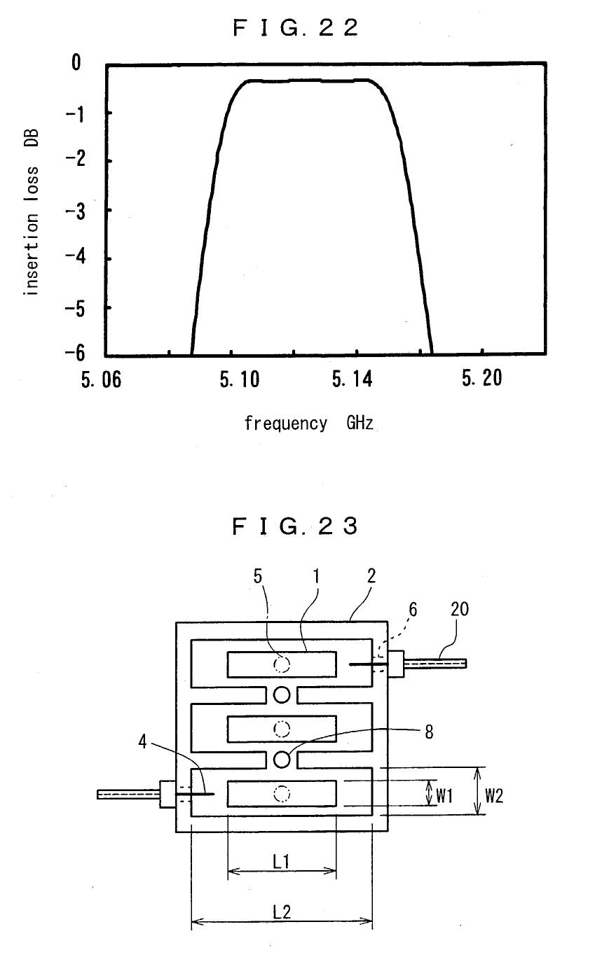

FIG. 22 shows the frequency characteristics of this high frequency filter, which are excellent.

In addition, a plurality of dielectric materials 1 may be aligned in the width direction perpendicular to the longitudinal direction and, thereby, a high frequency filter may be formed and an example thereof is shown in the horizontal cross-sectional view of FIG. 23.

It is preferable for ratio (L1/W1) of length L1 in the longitudinal direction of the dielectric material 1 to length W1 in the width direction perpendicular to the longitudinal direction to be 0.45, or greater, in the same manner as in Example 7 of the above-described Embodiment 1 and it is particularly preferable for it to be from approximately 4.5 to 10.

Thereby, the resonant frequency of the TM_{11δ} mode and the resonant frequency of the adjacent mode can be separated from each other.

It is preferable to apply the above-described Embodiment 1 in order to manufacture the high frequency filter of FIG. 21, wherein the length gained by dividing the length in the longitudinal direction of the shielding cavity 2 by the number (3 in this case) of the dielectric materials 1 aligned in the longitudinal direction, or the length between inter-section coupling adjustment screws 8, is regarded as length L2 in the longitudinal direction of the shielding cavity 2 in the above-described Embodiment 1.

Here FIGS. 21 and 23 show lengths L1and L2 in the longitudinal direction of the dielectric materials 1 and of the shielding cavity 2, as well as lengths W1 and W2 in the width direction perpendicular to the longitudinal direction of the dielectric materials 1 and of the shielding cavity 2, respectively.

It is also preferable in a high frequency filter for ratio (L2/L1) of length L2 in the longitudinal direction of the inside of the shielding cavity 2 to length L1in the longitudinal direction of the dielectric material 1 to be 1.10, or greater, in the same manner as in Example 2 of the above-described Embodiment 1.

In addition, it is preferable for ratio (L2/L1) of length L2 in the longitudinal direction of the inside of the shielding cavity 2 to length L1in the longitudinal direction of the dielectric material 1 to be from 1.27 to 2.04, while it is preferable for ratio (W1/W2) of length W1 of one side in the width direction perpendicular to the longitudinal direction of the dielectric material 1 to length W2 of one side in the width direction perpendicular to the longitudinal direction of the inside of the shielding cavity 2 to be 0.60, or less, in the same manner as in Example 3 of the above-described Embodiment 1.

In addition, it is preferable for ratio (L2/L1) of length L2 in the longitudinal direction of the inside of the shielding cavity 2 to length L1 in the longitudinal direction of the dielectric material 1 to be from 1.56 to 2.0 while it is preferable for ratio (W1/W2) of length W1 of one side in the width direction perpendicular to the longitudinal direction of the dielectric material 1 to length W2 of one side in the width direction perpendicular to the longitudinal direction of the inside of the shielding cavity 2 to be 0.64, or less, in the same manner as in Example 4 of the above-described Embodiment 1.

In addition, it is preferable for ratio (L2/L1) of length L2 in the longitudinal direction of the inside of the shielding cavity 2 to length L1 in the longitudinal direction of the dielectric material 1 to be from 1.20 to 3.0, while it is preferable for ratio (W1/W2) of length W1 of one side in the width direction perpendicular to the longitudinal direction of the dielectric material 1 to length W2 of one side in the width direction perpendicular to the longitudinal direction of the inside of the shielding cavity 2 to be 0.50, or less, in the same manner as in Example 5 of the above-described Embodiment 1.

In addition, it is preferable for ratio (L2/L1) of length L2 in the longitudinal direction of the inside of the shielding cavity 2 to length L1 in the longitudinal direction of the dielectric material 1 to be from 1.27 to 2.33, while it is preferable for ratio (W1/W2) of length W1 of one side in the width direction perpendicular to the longitudinal direction of the dielectric material 1 to length W2 of one side in the width direction perpendicular to the longitudinal direction of the inside of the shielding cavity 2 to be 0.42, or less, in the same manner as in Example 6 of the above-described Embodiment 1.

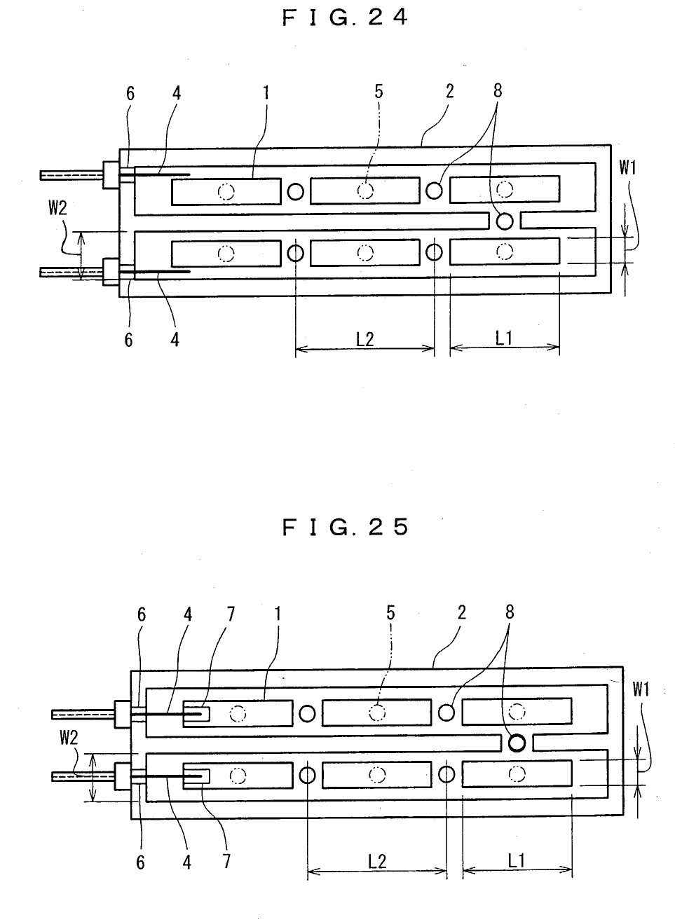

Furthermore, coupling antennas 4 in each of the above-described high frequency filters may-be extended in the longitudinal direction so as to be along the sides of the dielectric materials 1 as shown, for example, in FIG. 24 or the end portions of the coupling antennas 4 may be inserted into antenna insertion holes 7 created in the dielectric materials 1, as shown in FIG. 25, in the same manner as in the above-described Embodiment 2.

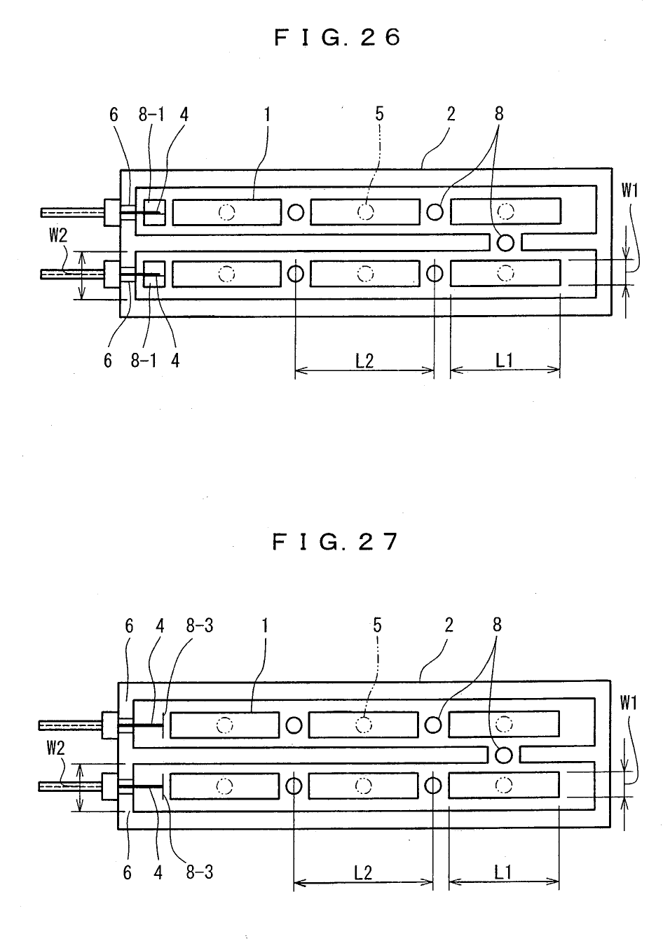

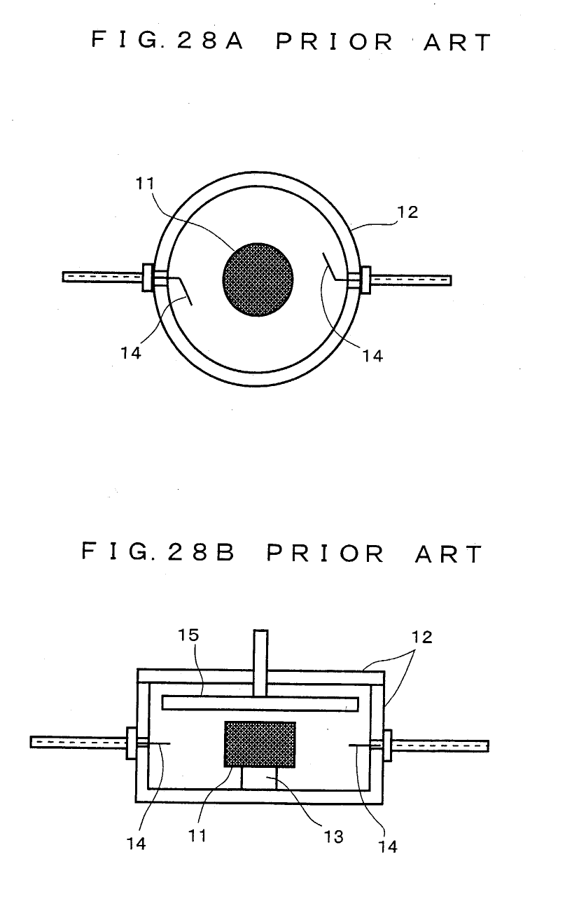

In addition, coupling bodies in plate forms may be provided to the coupling antennas 4 as shown, for example, in FIGS. 26 and 27 in the same manner as in the above-described Embodiments 3 to 7.

While there has been described what is at present considered to be preferred embodiments of this invention, it will be understood that various modifications may be made therein, and it is intended to cover in the appended claims all such modifications as fall within the true spirit and scope of this invention.

What is claimed is:

1. A dielectric resonator that is excited in the TM mode comprising: a dielectric material; a shielding cavity surrounding the dielectric material; and coupling antennas attached to the shielding cavity so as to penetrate from the outside to the inside of the shielding cavity.

2. The dielectric resonator according to claim 1, wherein the dielectric material is formed in a pillar form extending in the longitudinal direction, wherein the shielding cavity is formed to be hollow and extends in the longitudinal direction and wherein the dielectric material is secured to the inside of the shielding cavity so that the longitudinal direction of the dielectric material is along the longitudinal direction of the shielding cavity.

3. The dielectric resonator according to claim 1, wherein the coupling antennas are connected to conductors in the centers of coaxial cables.

4. The dielectric resonator according to claim 1, wherein the dielectric material is secured to the inside of the shielding cavity by means of a support member.

5. The dielectric resonator according to claim 2, wherein the ratio of the longitudinal direction of the dielectric material to the length in the width direction perpendicular to the longitudinal direction is 4.5, or greater.

6. The dielectric resonator according to claim 2, wherein the ratio of the length in the longitudinal direction of the inside of the shielding cavity to the length in the longitudinal direction of the dielectric material is greater than 1.10.

7. The dielectric resonator according to claim 2, wherein the ratio of the length in the width direction perpendicular to the longitudinal direction of the dielectric material to the length in the width direction perpendicular to the longitudinal direction of the inside of the shielding cavity is 0.64, or less.

8. The dielectric resonator according to claim 2, wherein the ratio of the length in the longitudinal direction of the inside of the shielding cavity to the length in the longitudinal direction of the dielectric material is from 1.27 to 2.04, wherein the ratio of the length in the width direction perpendicular to the longitudinal direction of the dielectric material to the length in the width direction perpendicular to the longitudinal direction of the inside of the shielding cavity is 0.60, or less, and wherein the dielectric material is a dielectric ceramic having a relative dielectric constant of from 40 to 50.

9. The dielectric resonator according to claim 2, wherein the ratio of the length in the longitudinal direction of the inside of the shielding cavity to the length in the longitudinal direction of the dielectric material is from 1.56 to 2.0, wherein the ratio of the length in the width direction perpendicular to the longitudinal direction of the dielectric material to the length in the width direction perpendicular to the longitudinal direction of the inside of the shielding cavity is 0.64, or less, and wherein the dielectric material is a dielectric ceramic having a relative dielectric constant of from 40 to 50.

10. The dielectric resonator according to claim 2, wherein the ratio of the length in the longitudinal direction of the inside of the shielding cavity to the length in the longitudinal direction of the dielectric material is from 1.20 to 3.0, wherein the ratio of the length in the width direction perpendicular to the longitudinal direction of the dielectric material to the length in the width direction perpendicular to the longitudinal direction of the inside of the shielding cavity is 0.50, or less, and wherein the dielectric material is a dielectric ceramic having a relative dielectric constant of from 32 to 37.

11. The dielectric resonator according to claim 2, wherein the ratio of the length in the longitudinal direction of the inside of the shielding cavity to the length in the longitudinal direction of the dielectric material is from 1.27 to 2.33, wherein the ratio of the length in the width direction perpendicular to the longitudinal direction of the dielectric material to the length in the width direction perpendicular to the longitudinal direction of the inside of the shielding cavity is 0.42, or less, and wherein the dielectric material is a dielectric ceramic having a relative dielectric constant of from 32 to 37.

12. The dielectric resonator according to claim 2, wherein the coupling antennas are connected to the conductors in the centers of coaxial cables and wherein the portions of the coupling antennas that are inserted into the shielding cavities extend in the longitudinal direction of the dielectric material and the ends of the portions extend to positions between the dielectric material and the inner surfaces of the shielding cavity.

13. The dielectric resonator according to claim 2, wherein the coupling antennas are connected to the conductors in the centers of coaxial cables and wherein the portions of the coupling antennas that are inserted into the shielding cavities extend in the longitudinal direction of the dielectric material and the ends of the portions are inserted into antenna insertion holes created in the longitudinal direction of the dielectric material.

14. The dielectric resonator according to claim 1, wherein the coupling antennas are formed in line forms, wherein the portions of the coupling antennas that are inserted into the shielding cavity are provided with conductive coupling bodies that extend to the outside of the coupling antennas in line forms so as to become larger than the line diameters of the coupling antennas and wherein the coupling bodies at least a part of the coupling bodies have portions with thicknesses no greater than the line diameters.

15. The dielectric resonator according to claim 1, wherein the coupling antennas are formed in line forms, wherein the portions of the coupling antennas that are inserted into the shielding cavity are provided with coupling bodies in plate forms larger than the line diameters of the coupling antennas and wherein the coupling bodies are conductive, and at least a part of the coupling bodies have portions with thicknesses no greater than the line diameters.

16. The dielectric resonator according to claim 15, wherein the thicknesses of the coupling bodies in plate forms are no greater than the line diameters.

17. The dielectric resonator according to claim 15, wherein the coupling bodies have a plurality of portions in the plate forms.

18. The dielectric resonator according to claim 15, wherein the dielectric material is formed in a pillar form extending in the longitudinal direction, wherein the shielding cavity is formed to be hollow and extends in the longitudinal direction, wherein the dielectric material is secured to the inside of the shielding cavity so that the longitudinal direction of the dielectric material is in the longitudinal direction of the shielding cavity and wherein the portions in the plate forms are placed between the end surfaces perpendicular to the longitudinal direction of the dielectric material and the inner surfaces of the shielding cavity so that the plate surfaces of the portions in the plate forms are oriented in the longitudinal direction of the dielectric material.

19. The dielectric resonator according to claim 15, wherein the dielectric material is formed in a pillar form extending in the longitudinal direction, wherein the shielding cavity is formed to be hollow and extends in the longitudinal direction, wherein the dielectric material is secured to the inside of the shielding cavity so that the longitudinal direction of the dielectric material is in the longitudinal direction of the shielding cavity and wherein the portions in the plate forms are placed between the surfaces in the longitudinal direction of the dielectric material and the inner surfaces of the shielding cavity so that the plate surfaces of the portions in the plate forms are oriented in the longitudinal direction of the dielectric material.

20. A high frequency circuit element, comprising a dielectric resonator that can become excited in the TM mode having: a dielectric material that becomes a resonating part; a shielding cavity surrounding the dielectric material; and input/output communication paths formed of coupling antennas.

21. The high frequency circuit element according to claim 20, wherein the dielectric material is formed in a pillar form extending in the longitudinal direction, wherein the shielding cavity is formed to be hollow and extends in the longitudinal direction and wherein the dielectric material is secured to the inside of the shielding cavity so that the longitudinal direction of the dielectric material is along the longitudinal direction of the shielding cavity.

22. The high frequency circuit element according to claim 20, wherein the coupling antennas are connected to conductors in the centers of coaxial cables.

23. The high frequency circuit element according to claim 20, wherein the dielectric material is secured to the inside of the shielding cavity by means of a support member.

24. The high frequency circuit element according to claim 21, wherein the ratio of the length in the longitudinal direction to the length in the width direction perpendicular to the longitudinal direction of the dielectric material is 4.5, or greater.

25. The high frequency circuit element according to claim 21, wherein the ratio of the length in the longitudinal direction of the inside of the shielding cavity to the length in the longitudinal direction of the dielectric material is greater than 1.10.

26. The high frequency circuit element according to claim 21, wherein the ratio of the length in the width direction perpendicular to the longitudinal direction of the dielectric material to the length in the width direction perpendicular to the longitudinal direction of the inside of the shielding cavity is 0.64, or less.

27. The high frequency circuit element according to claim 21, wherein the ratio of the length in the longitudinal direction of the inside of the shielding cavity to the length in the longitudinal direction of the dielectric material is from 1.27 to 2.04, wherein the ratio of the length in the width direction perpendicular to the longitudinal direction of the dielectric material to the length in the width direction perpendicular to the longitudinal direction of the inside of the shielding cavity is 0.60, or less, and wherein the dielectric material is a dielectric ceramic having a relative dielectric constant of from 40 to 50.

28. The high frequency circuit element according to claim 21, wherein the ratio of the length in the longitudinal direction of the inside of the shielding cavity to the length in the longitudinal direction of the dielectric material is from 1.56 to 2.0, wherein the ratio of the length in the width direction perpendicular to the longitudinal direction of the dielectric material to the length in the width direction perpendicular to the longitudinal direction of the inside of the shielding cavity is 0.64, or less, and wherein the dielectric material is a dielectric ceramic having a relative dielectric constant of from 40 to 50.

29. The high frequency circuit element according to claim 21, wherein the ratio of the length in the longitudinal direction of the inside of the shielding cavity to the length in the longitudinal direction of the dielectric material is from 1.20 to 3.0, wherein the ratio of the length in the width direction perpendicular to the longitudinal direction of the dielectric material to the length in the width direction perpendicular to the longitudinal direction of the inside of the shielding cavity is 0.50, or less, and wherein the dielectric material is a dielectric ceramic having a relative dielectric constant of from 32 to 37.

30. The high frequency circuit element according to claim 21, wherein the ratio of the length in the longitudinal direction of the inside of the shielding cavity to the length in the longitudinal direction of the dielectric material is from 1.27 to 2.33, wherein the ratio of the length in the width direction perpendicular to the longitudinal direction of the dielectric material to the length in the width direction perpendicular to the longitudinal direction of the inside of the shielding cavity is 0.42, or less, and wherein the dielectric material is a dielectric ceramic having a relative dielectric constant of from 32 to 37.

31. The high frequency circuit element according to claim 21, wherein the coupling antennas are connected to the conductors in the centers of coaxial cables and wherein the portions of the coupling antennas that are inserted into the shielding cavities extend in the longitudinal direction of the dielectric material and the ends of the portions extend to positions between the dielectric material and the inner surfaces of the shielding cavity.

32. The high frequency circuit element according to claim 21, wherein the coupling antennas are connected to the conductors in the centers of coaxial cables and wherein the portions of the coupling antennas that are inserted into the shielding cavities extend in the longitudinal direction of the dielectric material and the ends of the portions are inserted into antenna insertion holes created in the longitudinal direction of the dielectric material.

33. The high frequency circuit element according to claim 20, wherein the coupling antennas are formed in line forms, wherein the portions of the coupling antennas that are inserted into the shielding cavity are provided with conductive coupling bodies that extend to the outside of the coupling antennas in line forms so as to become larger than the line diameters of the coupling antennas and wherein the coupling bodies, at least a part of the coupling bodies have portions with thicknesses no greater than the line diameters.

34. The high frequency circuit element according to claim 20, wherein the coupling antennas are formed in line forms, wherein the portions of the coupling antennas that are inserted into the shielding cavity are provided with coupling bodies in plate forms larger than the line diameters of the coupling antennas and wherein the coupling bodies are conductive, and at least a part of the coupling bodies have portions with thicknesses no greater than the line diameters.

35. The high frequency circuit element according to claim 34, wherein the thicknesses of the coupling bodies in plate forms are no greater than the line diameters.

36. The high frequency circuit element according to claim 34, wherein the coupling bodies have a plurality of portions in the plate forms.

37. The high frequency circuit element according to claim 34, wherein the dielectric material is formed in a pillar form extending in the longitudinal direction, wherein the shielding cavity is formed to be hollow and extends in the longitudinal direction, wherein the dielectric material is secured to the inside of the shielding cavity so that the longitudinal direction of the dielectric material is in the longitudinal direction of the shielding cavity and wherein the portions in the plate forms are placed between the end surfaces perpendicular to the longitudinal direction of the dielectric material and the inner surfaces of the shielding cavity so that the plate surfaces of the portions in the plate forms are oriented in the longitudinal direction of the dielectric material.

38. The high frequency circuit element according to claim 34, wherein the dielectric material is formed in a pillar form extending in the longitudinal direction, wherein the shielding cavity is formed to be hollow and extends in the longitudinal direction, wherein the dielectric material is secured to the inside of the shielding cavity so that the longitudinal direction of the dielectric material is in the longitudinal direction of the shielding cavity and wherein the portions in the plate forms are placed between the surfaces in the longitudinal direction of the dielectric material and the inner surfaces of the shielding cavity so that the plate surfaces of the portions in the plate forms are oriented in the longitudinal direction of the dielectric material.
